(19) United States
(12) Patent Application Publication
(10) Pub. No.: US 2018/0363606 A1
(43) Pub. Date: Dec. 20, 2018

(54) RETURN FUEL RECYCLING MANIFOLD

(71) Applicant: Cummins Inc., Columbus, IN (US)

(72) Inventors: Ashwin Balaji, Columbus, IN (US); Josh Si Shao, Columbus, IN (US); Minming Zhao, Columbus, IN (US)

(21) Appl. No.: 15/622,830

(22) Filed: Jun. 14, 2017

(51) Int. Cl. F02M 37/00; F02M 55/00; F02M 37/22; F02M 31/02

(52) U.S. Cl. CPC F02M 37/0052; F02M 55/00; F02M 31/02; F02M 37/007; F02M 37/22

(57) ABSTRACT

An engine mounted fuel manifold configured to inhibit gelling of fuel is provided, comprising: a housing comprising an internal chamber configured to receive drain fuel from a pump, an accumulator and a fuel injector, and a recirculation passage in fluid communication with the internal chamber to receive the drain fuel; a tank fuel port configured to receive fuel from a fuel tank; an output port configured to output fuel to a filter; a fuel supply passage in communication with the tank fuel port and the output port; and a thermal recirculation valve in fluid communication with the recirculation passage and the fuel supply passage, the valve responding to temperatures of fuel received by the tank fuel port being below a predetermined value by mixing drain fuel from the recirculation passage with fuel in the fuel supply passage, thereby causing mixed fuel to be supplied to the filter.

### FIELD OF THE DISCLOSURE

The present disclosure generally relates to fueling systems for engines and more specifically to a manifold for selectively mixing drain fuel with supply fuel to inhibit fuel gelling in the fuel supply path.

### BACKGROUND OF THE DISCLOSURE

Some engines experience fuel gelling during cold weather operating conditions, particularly at the first stage filter of the fuel supply path. Such fuel gelling causes restriction in the fuel supply and results in a variety of engine performance issues such as excessive emissions due to extended fuel injection events. While filter clogging from fuel gelling can be corrected, the additional smoke generated before the correction may require cleaning of the DPF. As such, fuel gelling is generally to be avoided.

In diesel engines, one way to avoid fuel gelling is by using a fuel blend having a high percentage of diesel #1 fuel (i.e., standard diesel fuel, sometimes called diesel oil) and a low percentage of diesel #2 fuel. As shown in FIG. 1, 100 percent #1 fuel has a cloud point (i.e., the temperature at which the fuel begins to gel or become foggy) of below −20° F. and a pour point of below −30° F. 100 percent #2 fuel, on the other hand, has a cloud point of approximately 15° F. and a pour point of approximately 5° F. Thus, fuel blends with high percentages of #1 fuel will not gel except under extremely cold conditions.

#1 fuel, however, is more difficult to produce and is more expensive than #2 fuel. Moreover, #1 fuel is less available at filling stations, particularly in warmer climates. Thus, a truck operator may want to purchase #1 fuel in Texas for a trip to Minnesota but be unable to locate a filling station in Texas that offers #1 fuel. Finally, as the energy content of #2 fuel is higher than that of #1 fuel, #2 fuel provides better fuel economy. As such, it is desirable to use #2 fuel (or blends with high percentages of #2 fuel) because it is less expensive, provides better fuel economy and is more available. Unfortunately, as shown in FIG. 1, #2 fuel is also much more susceptible to gelling. Thus, an approach is needed to inhibit fuel gelling under cold weather conditions and provide users the ability to select any type of fuel.

### SUMMARY

In one embodiment, the present disclosure provides an engine mounted fuel manifold configured to inhibit gelling of fuel provided to a filter by mixing low temperature fuel from a fuel tank with higher temperature drain fuel from the engine, the manifold comprising: a housing comprising an internal chamber configured to receive drain fuel from a fuel pump, a fuel accumulator and at least one fuel injector, and a recirculation passage in fluid communication with the internal chamber to receive the drain fuel; a tank fuel port configured to receive fuel from the fuel tank; an output port configured to output fuel to the filter; a fuel supply passage in communication with the tank fuel port and the output port; and a thermal recirculation valve in fluid communication with the recirculation passage and the fuel supply passage, the valve being configured to respond to temperatures of fuel received by the tank fuel port being below a predetermined value by mixing drain fuel from the recirculation passage with fuel in the fuel supply passage, thereby causing mixed fuel to be supplied from the output port to the filter. In one aspect of this embodiment, the housing comprises a drain fuel housing and a thermal recirculation valve housing extending from the drain fuel housing, the internal chamber being disposed in the drain fuel housing, the fuel supply passage being disposed in the thermal recirculation valve housing and the recirculation passage extending between the drain fuel housing and the thermal recirculation valve housing. Another aspect further comprises a mounting flange extending from the housing and configured to receive at least one fastener to attach the housing to the engine. In another aspect, the housing comprises a high pressure pump (“HPP”) port configured to receive drain fuel from a HPP, a rail port configured to receive drain fuel from a fuel accumulator, an injector port configured to receive drain fuel from at least one fuel injector, and a drain port configured to provide drain fuel to the fuel tank, the HPP port, the rail port, the injector port and the drain port being in fluid communication with the internal chamber. In still another aspect of this embodiment, the thermal recirculation valve responds to temperatures of fuel received by the tank fuel port being above the predetermined value by moving to a fully closed position and responds to temperatures of fuel received by the tank fuel port being in a temperature range below the predetermined value by moving to a partially opened position. In a variant of this aspect, the thermal recirculation valve responds to temperatures of fuel received by the tank fuel port being below the temperature range by moving to a fully opened position. In a further variant, the thermal recirculation valve is movable between a plurality of partially opened positions in response to a corresponding plurality of temperatures of fuel received by the fuel tank port within the temperature range.

According to another embodiment, the present disclosure provides a fuel manifold, comprising: a mounting flange configured to mount the manifold to an engine; a drain fuel housing extending from the mounting flange; and a thermal recirculation valve (“TRV”) housing extending from the drain fuel housing; the drain fuel housing comprising a high pressure pump (“HPP”) port configured to receive drain fuel from an HPP, a rail port configured to receive drain fuel from a fuel accumulator, an injector port configured to receive drain fuel from at least one fuel injector, a drain port configured to output drain fuel to a fuel tank, an internal chamber in fluid communication with the HPP port, the rail port, the injector port and the drain port, and a recirculation passage in fluid communication with the internal chamber; the TRV housing comprising a tank fuel port configured to receive fuel from the fuel tank, an output port configured to output fuel to a filter that supplies fuel to the engine, and a valve in fluid communication with the recirculation passage, the tank fuel port and the output port; wherein the valve is configured to permit fuel flow from the recirculation passage to the output port in response to a temperature of fuel received by the tank fuel port being below a predetermined value, thereby increasing a temperature of fuel output by the output port to the filter and inhibiting fuel gelling. In one aspect of this embodiment, the valve responds to temperatures of fuel received by the tank fuel port being above the predetermined value by moving to a fully closed position and responds to temperatures of fuel received by the tank fuel port being in a temperature range below the predetermined value by moving to a partially opened position. In a variant of this aspect, the valve responds to temperatures of fuel received by the tank fuel port being below the temperature range by moving to a fully opened position. In a further variant, the valve is movable between a plurality of partially opened positions in response to a corresponding plurality of temperatures of fuel received by the fuel tank port within the temperature range.

In still another embodiment, the present disclosure provides a method of inhibiting gelling in an engine fuel supply path under low temperature operating conditions, comprising: routing drain fuel from a fuel pump, a fuel accumulator and at least one fuel injector to an internal chamber of a fuel manifold; routing tank fuel from a fuel tank through a fuel supply passage in the fuel manifold to a filter in the fuel supply path; mixing drain fuel from the internal chamber with tank fuel in the fuel supply passage in response to the tank fuel being below a predetermined temperature; and providing the mixed fuel to the filter. In one aspect of this embodiment, mixing comprises providing a thermal recirculation valve between the internal chamber and the fuel supply passage, the thermal recirculation valve responding to the tank fuel being below the predetermined temperature by moving to an opened position, thereby routing drain fuel from the internal chamber to the fuel supply passage. In a variant of this aspect, the method further comprises routing drain fuel from the internal chamber through a recirculation passage in communication with the internal chamber and the thermal recirculation valve. In another aspect, the method further comprises mounting the fuel manifold to an engine.

In yet another embodiment, the present disclosure provides a vehicle mounted fuel manifold assembly for inhibiting gelling of fuel provided to a filter in low temperature conditions by mixing low temperature fuel from a fuel tank with higher temperature drain fuel from an engine, the assembly comprising: a manifold housing comprising a drain input port, a drain output port, a tank fuel port, an output port, a first passage in flow communication with the drain input port and the drain output port, a second passage in flow communication with the tank fuel port and the output port, and a thermal recirculation valve in flow communication with the first passage and the second passage; a bracket configured to mount to the vehicle; at least one fastener for mounting the manifold housing to the bracket; and a conduit comprising a first end configured to couple to a drain port on the engine, a second end configured to couple to the drain input port of the manifold housing and a body configured to transport fuel from the drain port on the engine to the drain input port of the manifold housing; wherein the thermal recirculation valve is configured to respond to a temperature of fuel received from the fuel tank by the tank fuel port being below a predetermined value by routing higher temperature drain fuel from the first passage to the second passage to increase the temperature of fuel provided from the output port to the filter to inhibit gelling. In one aspect of this embodiment, the thermal recirculation valve responds to temperatures of fuel received by the tank fuel port being above the predetermined value by moving to a fully closed position and responds to temperatures of fuel received by the tank fuel port being in a temperature range below the predetermined value by moving to a partially opened position. In a variant of this aspect, the thermal recirculation valve responds to temperatures of fuel received by the tank fuel port being below the temperature range by moving to a fully opened position. In a further variant, the thermal recirculation valve is movable between a plurality of partially opened positions in response to a corresponding plurality of temperatures of fuel received by the fuel tank port within the temperature range. In still a further variant, the manifold housing further comprises a recirculation passage in communication with the first passage and the thermal recirculation valve.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is a graph depicting thermal performance characteristics of fuel blends;

FIG. 2 is a schematic diagram of a prior art engine fueling configuration;

FIG. 3 is a schematic diagram of an engine fueling configuration according to the principles of the present disclosure;

FIG. 4 is a side view of an engine showing a prior art fuel manifold;

FIG. 5 is a side view of an engine showing a fuel manifold according to one embodiment of the present disclosure;

FIG. 6 is a perspective view of the fuel manifold of FIG. 5;

FIG. 7 is a side view of the fuel manifold of FIG. 5;

FIG. 8 is top cross-sectional view of the fuel manifold of FIG. 5 taken along line A-A of FIG. 7;

FIGS. 9 and 10 are side cross-sectional views of a thermal recirculation valve housing of the fuel manifold of FIG. 5;

FIG. 11 is a perspective view of a fuel manifold assembly according to one embodiment of the present disclosure;

FIG. 12 is a perspective view of the fuel manifold depicted in FIG. 11; and

FIG. 13 is a top cross-sectional view of the fuel manifold depicted in FIG. 11.

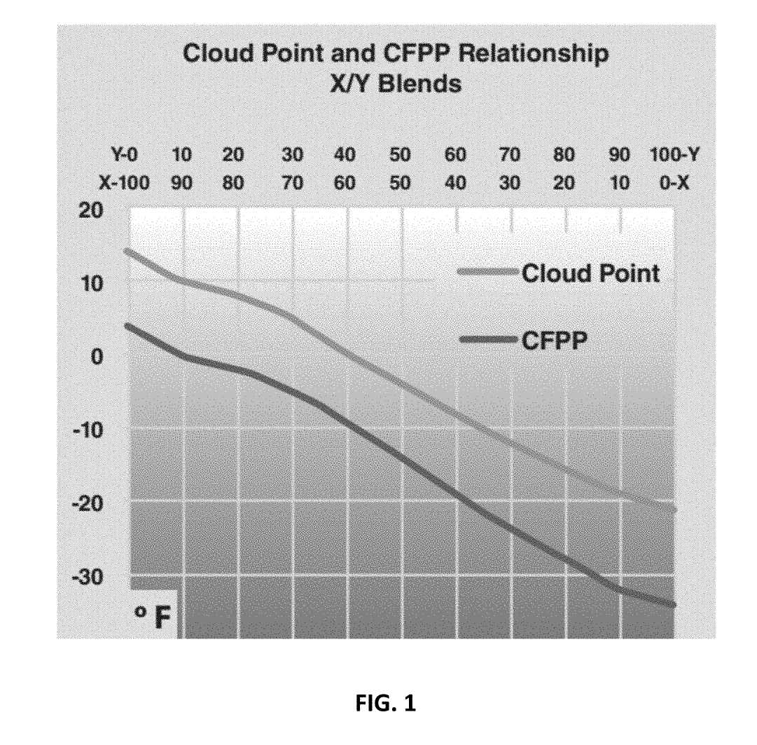

Corresponding reference characters indicate corresponding parts throughout the several views. The exemplifications set out herein illustrate exemplary embodiments of the disclosure and such exemplifications are not to be construed as limiting the scope of the disclosure in any manner.

### DETAILED DESCRIPTION

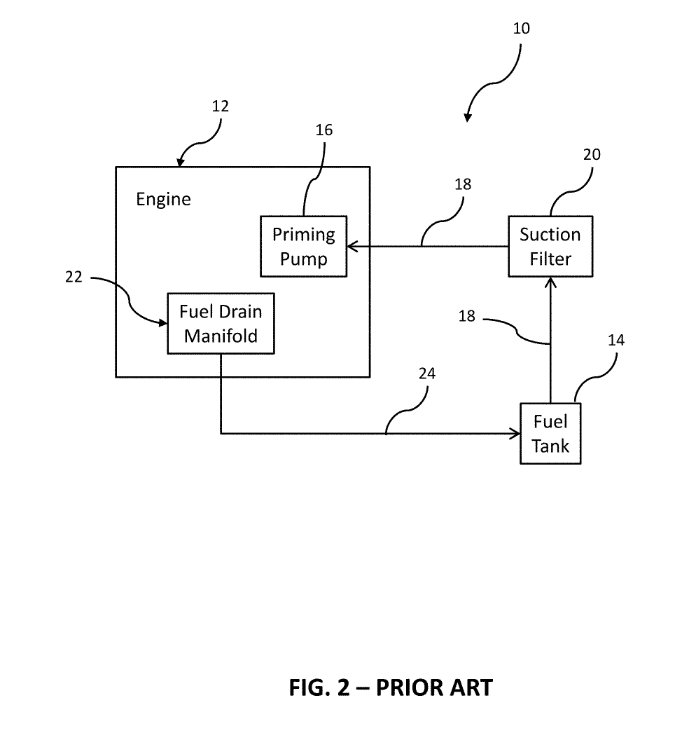

Referring now to FIG. 2, a prior art fueling configuration is shown. Configuration 10 is greatly simplified for clarity of the explanation. In general, an engine 12 is supplied fuel from a fuel tank 14. A priming pump 16 on engine 12 draws supply fuel 18 from fuel tank 14 through a first stage suction filter 20. The fuel then is provided through a variety of other components to the engine cylinders (not shown) for combustion to produce power. Portions of supply fuel 18 not supplied to the engine cylinders are drained from components such as a high pressure pump (“HPP”), a fuel accumulator (such as a common rail accumulator) and the fuel injectors. This drain fuel is routed to fuel drain manifold 22, which routes the drain fuel 24 back to fuel tank 14. In general, supply fuel 18 is at a lower temperature than drain fuel 24 because the primary volume of supply fuel 18 is stored in fuel tank 14, a distance away from the heat generated by combustion in engine 12. The drain fuel 24, on the other hand, is circulated through engine components that are in closer proximity to the high temperatures produced by combustion, and reaches increased temperatures. In configuration 10, fuel gelling typically occurs when the cold supply fuel 18 reaches filter 20.

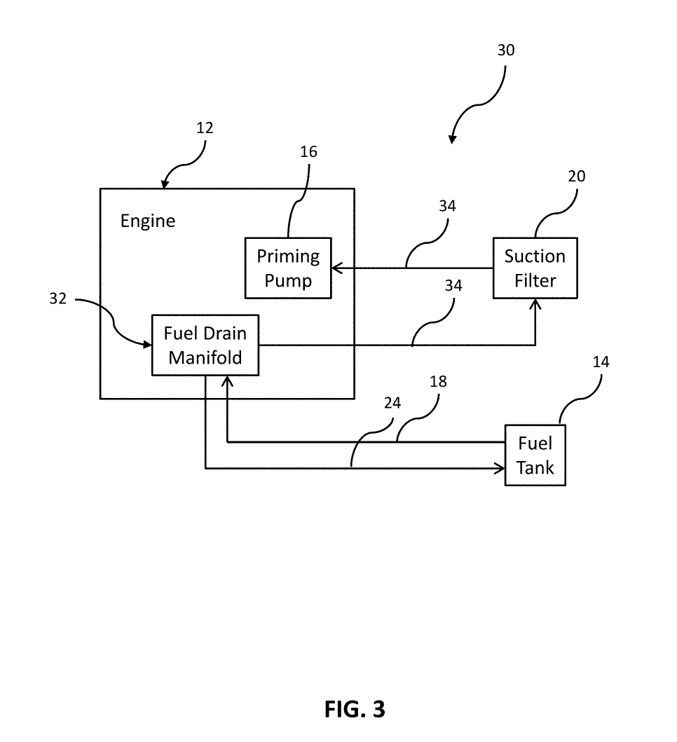

The present disclosure provides a fuel recirculation approach that mixes warm drain fuel 24 with cold supply fuel 18 to increase the temperature of the supply fuel to avoid fuel gelling. As shown schematically in FIG. 3, in fueling configuration 30 low temperature supply fuel 18 is routed from fuel tank 14 to suction filter 20 through a fuel drain manifold 32 according to the present disclosure. As is described in detail below, under certain cold weather operating conditions, higher temperature drain fuel 24 is mixed with the supply fuel 18 in manifold 32 to increase the temperature of the fuel provided to filter 20 and pump 16. The higher temperature of mixed fuel 34 inhibits gelling. As in configuration 10, drain fuel 24 that is not mixed with supply fuel 18 is routed back to fuel tank 14 from fuel drain manifold 32.

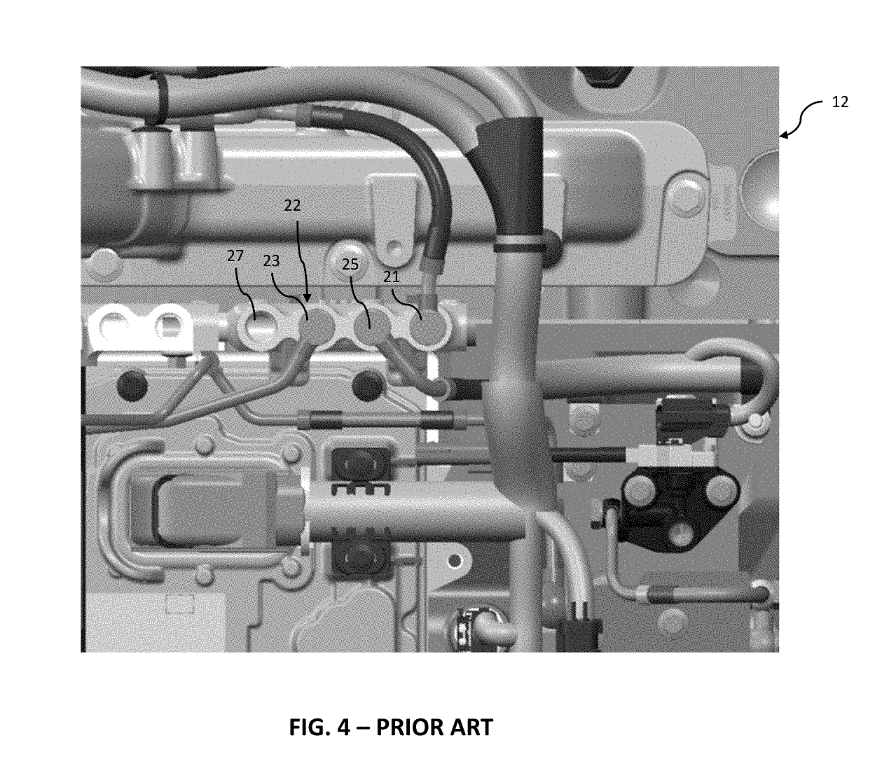

FIG. 4 shows a prior art fuel drain manifold 22 mounted to engine 12. Manifold 22 includes a rail port 21 which receives rail drain fuel from a fuel accumulator such as a common rail accumulator, an HPP port 23 which receives HPP drain fuel from an HPP, an injector port 25 which receives injector drain fuel from one or more fuel injectors and a drain port 27 which is configured to deliver drain fuel from manifold 22 to fuel tank 14 through a conduit.

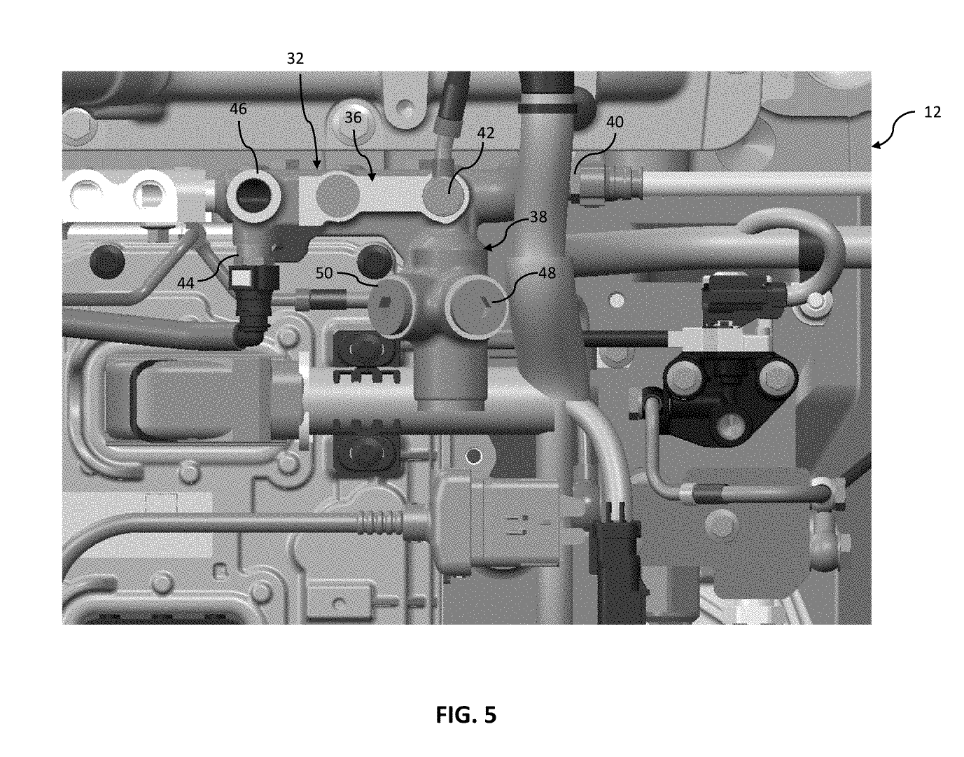

Referring now to FIG. 5, one embodiment of a fuel drain manifold 32 according to the present disclosure is depicted mounted to engine 12. As shown, manifold 32 generally includes a drain fuel housing 36 and a thermal recirculation valve housing 38 which extends from drain fuel housing. Drain fuel housing 36 includes an injector port 40, a rail port 42, an HPP port 44 and a drain port 46. As with prior art manifold 22, injector port 40 is configured to receive drain fuel from one or more fuel injectors, rail port 42 is configured to receive drain fuel from a fuel accumulator, HPP port 44 is configured to receive drain fuel from an HPP, and drain port 46 is configured to route drain fuel 24 to fuel tank 14 through a conduit. Thermal recirculation valve housing 38 includes a tank fuel port 48 which is configured to receive supply fuel 18 from fuel tank 14 and an output port 50 which is configured to output fuel (including mixed fuel 34) to filter 20.

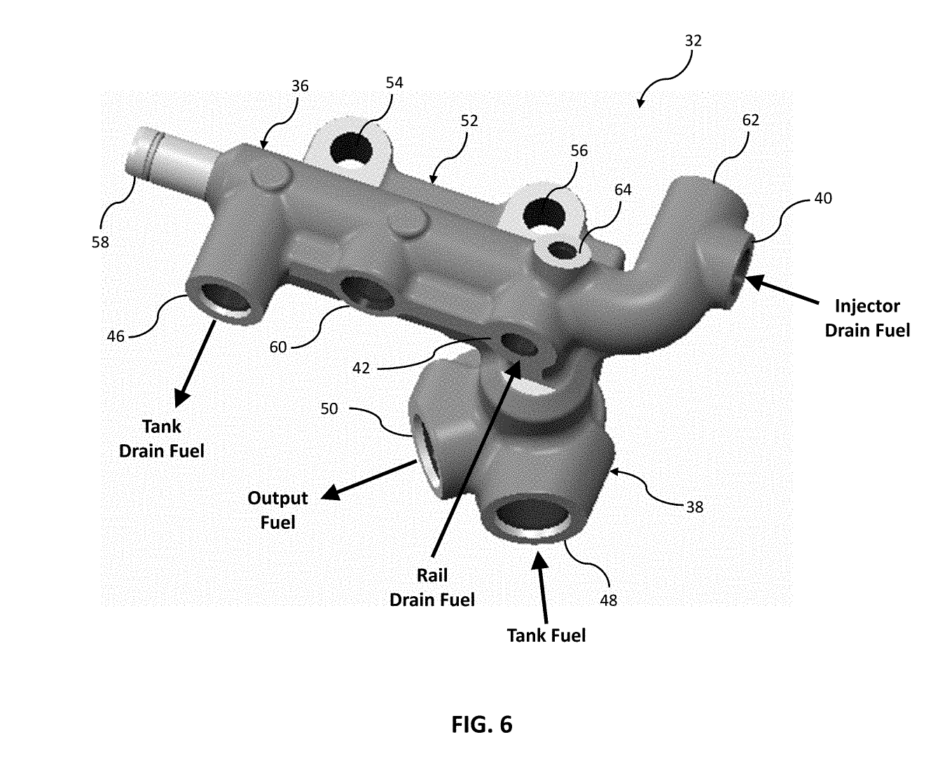

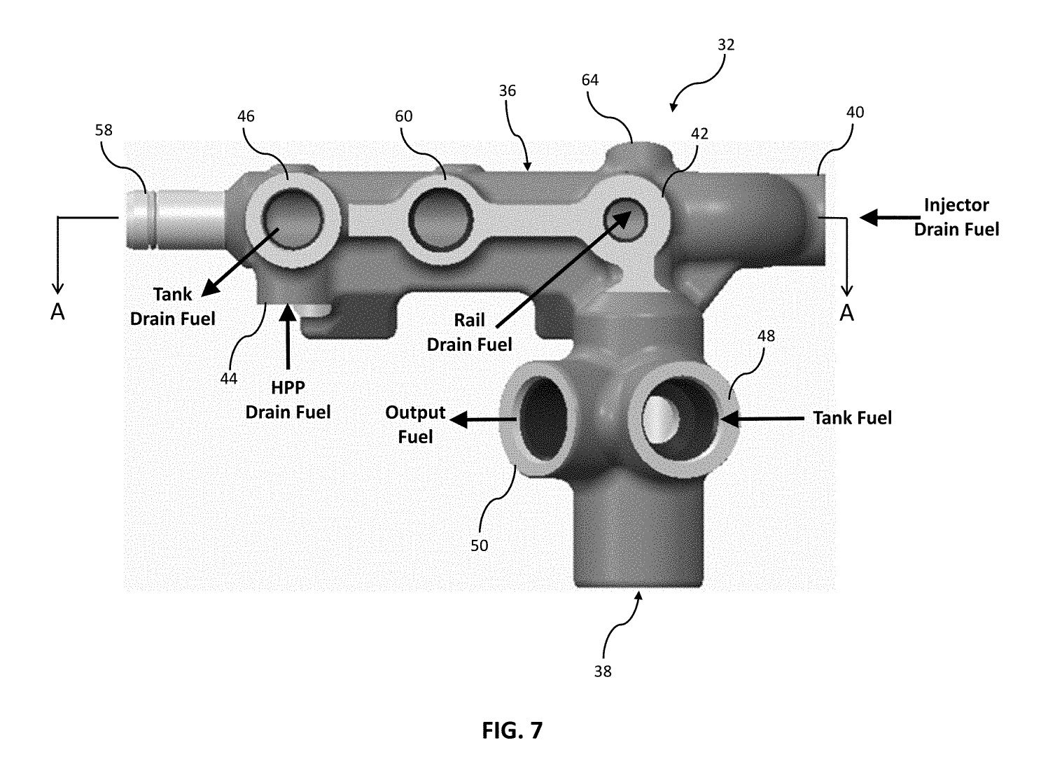

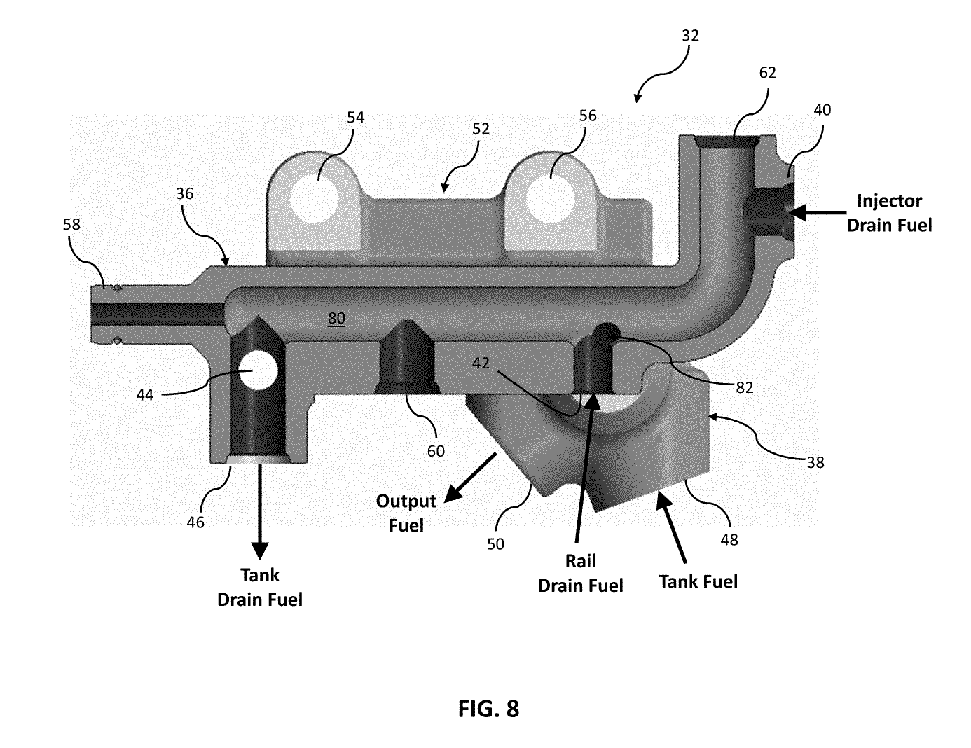

Referring now to FIGS. 6-8, manifold 32 is shown detached from engine 12. As best shown in FIGS. 6 and 8, in addition to injector port 40, rail port 42, HPP port 44 (FIG. 7) and drain port 46, drain fuel housing 36 also includes a mounting flange 52 extending from drain fuel housing 36. In one embodiment, mounting flange 52 includes a pair of openings 54, 56 which are sized to receive fasteners (not shown) used to attach manifold 32 to engine 12. Drain fuel housing 36 further includes an air bleed port 58 which is connected to an on-engine filter, a service port 60 which is normally plugged but available for troubleshooting purposes, opening 62 which is necessary for manufacturing manifold 32 but plugged during use, and opening 64 which is necessary for forming a recirculation passage described below but plugged during use. In one embodiment, manifold 32 is cast as one piece.

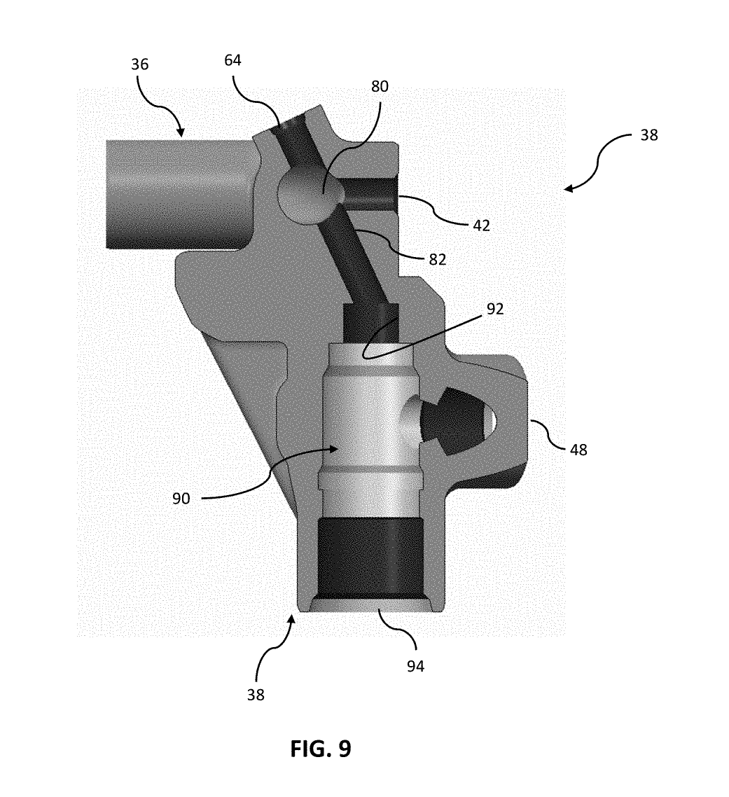

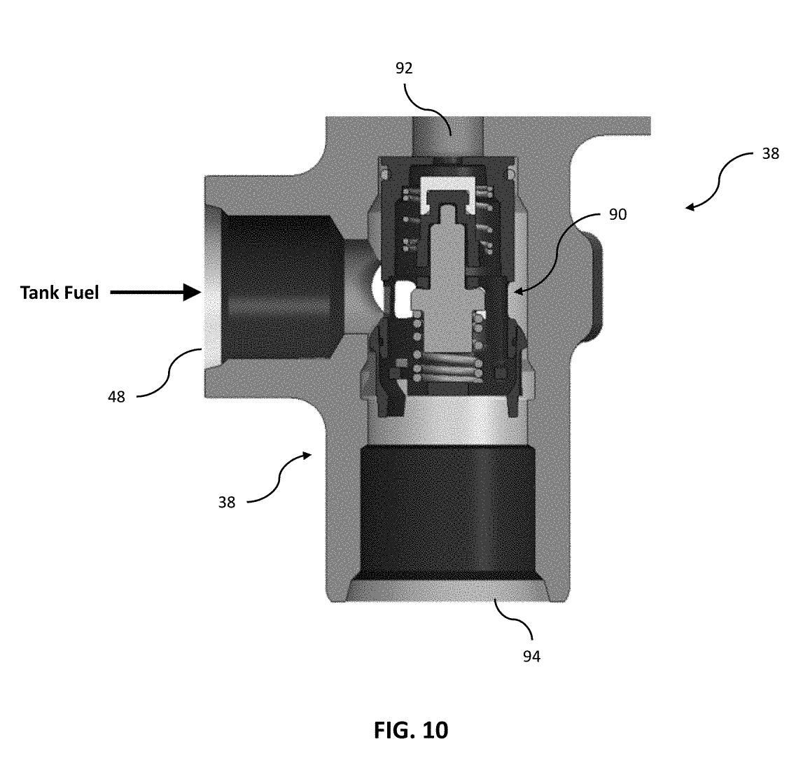

As best shown in FIG. 8, drain fuel housing 36 also includes an internal chamber 80 which is in flow communication with drain port 46, HPP port 44, rail port 42 and injector port 40. Internal chamber 80 collects drain fuel from HPP port 44, rail port 42 and injector port 40, and releases drain fuel from drain port 46 to fuel tank 14 in the manner described above. A recirculation passage 82 is in flow communication with internal chamber 80 to provide drain fuel to thermal recirculation valve housing 38. As best shown in FIG. 9, recirculation passage 82 is formed by drilling (creating opening 62 which is later plugged) through drain fuel housing 36 into thermal recirculation valve housing 28. Supply fuel is routed from fuel tank 14 to tank fuel port 48 of thermal recirculation valve housing 38, and provided from output port 50 to filter 20. The temperature of the supply fuel is sensed by a thermal recirculation valve 90 which is situated in a chamber 92 formed in thermal recirculation valve housing 38 as shown in FIGS. 9 and 10.

The operation and structure of valve 90 is described in detail in U.S. Pat. No. 9,163,596 (the '596 patent”), filed Jun. 26, 2013, entitled “THERMAL RECIRCULATOIN VALVE FOR FUEL FILTRATION MODULE,” which is co-owned by the applicant, the entire disclosure of which being expressly incorporated herein by reference. As shown in FIGS. 9 and 10, an opening 94 is formed in thermal recirculation valve housing 38 to permit insertion of valve 90 into chamber 92. Opening 94 is plugged after valve 90 is inserted. As explained in the '596 patent, valve 90 operates using a piston that is powered by a thermal wax element that expands with increases in temperature to move the piston and form a seal which inhibits, in this application, mixing of drain fuel with supply fuel flowing through tank fuel port 48 and output port 50. The thermal wax element in this application is exposed to the supply fuel received by tank fuel port 48 and thus responds to the temperature of the supply fuel by causing mixing of drain fuel with supply fuel under low temperature conditions and inhibiting mixing of drain fuel with supply fuel under higher temperature conditions.

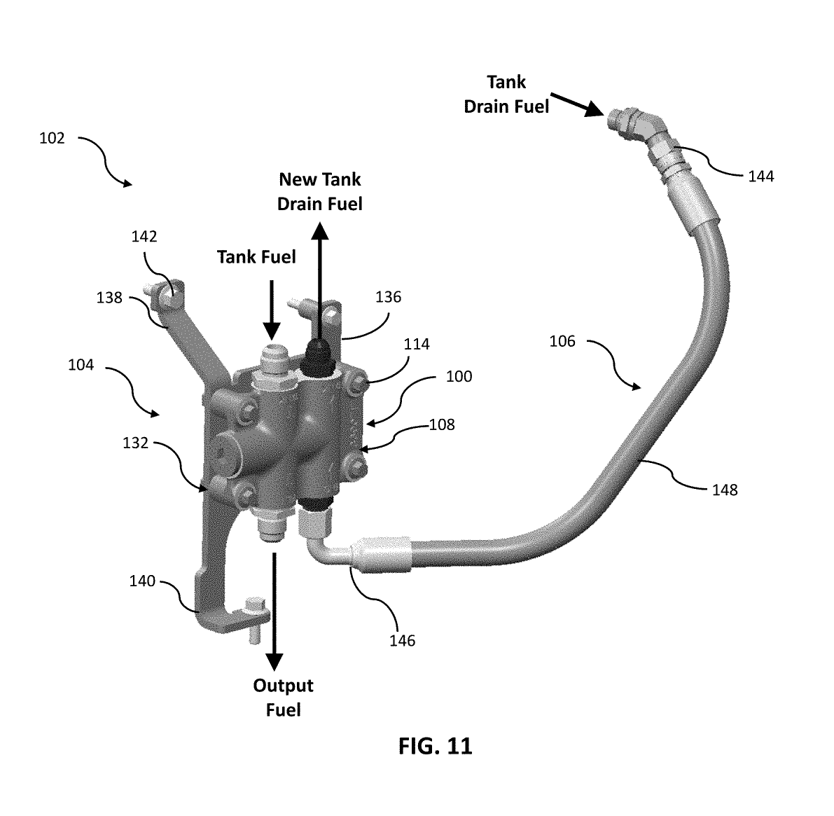

FIG. 11 depicts an alternate embodiment of the manifold of the present disclosure which is designed as an aftermarket solution to the problem of fuel gelling. In this embodiment, the manifold may be mounted on-engine or chassis mounted at the customer's discretion. As shown, manifold 100 is part of manifold assembly 102, which generally includes manifold 100, bracket 104, and conduit 106.

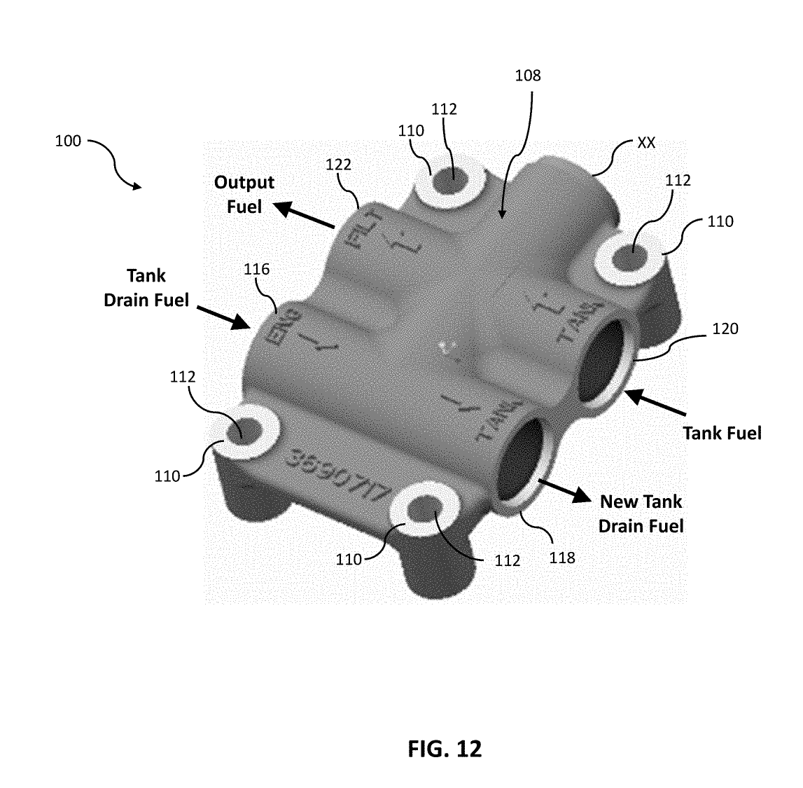

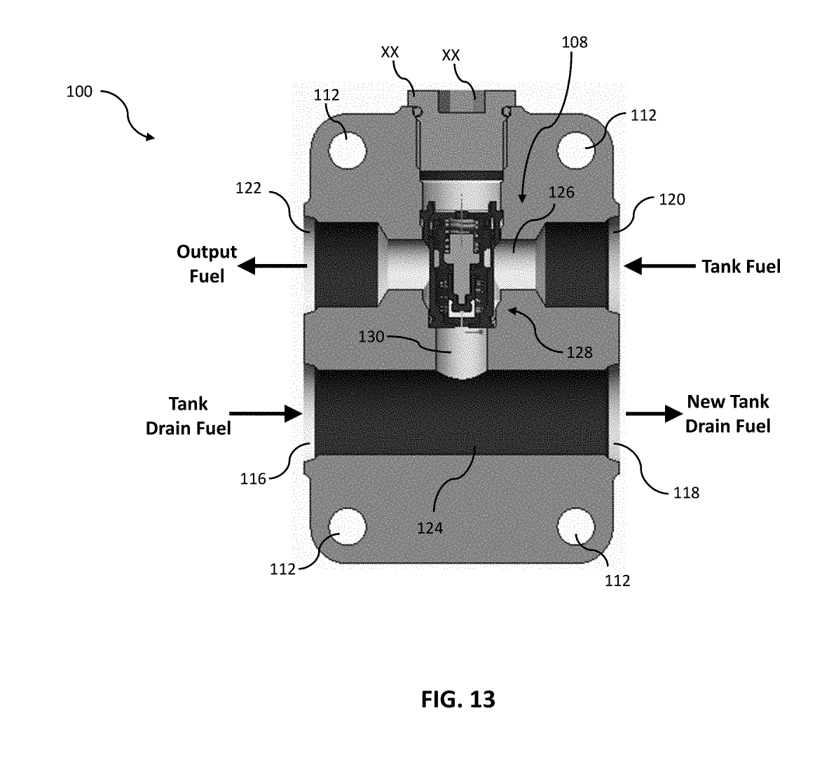

As best shown in FIGS. 12 and 13, manifold 100 includes a manifold housing 108 which includes a plurality of mounting bosses 110, each having an opening 112 for receiving a fastener 114 (FIG. 11) to mount housing 108 to bracket 104. Manifold housing 108 further includes a drain input port 116, a drain output port 118, a tank fuel port 120 and an output port 122. Drain input port 116 is in flow communication with drain output port 118 through a first passage 124. Tank fuel port 120 is in flow communication with output port 122 through a second passage 126. Second passage 126 is in flow communication with a thermal recirculation valve 128 of the kind described in the '596 patent, and thermal recirculation valve 128 is in flow communication with first passage 124 through recirculation passage 130.

When the temperature of tank fuel received by tank fuel port 120 is below a predetermined value (e.g., approximately 20 degrees Celsius), valve 128 moves to a partially opened position to route drain fuel from second passage 126 to first passage 124 to mix the drain fuel with the supply fuel and increase the temperature of fuel provided from output port 122 to filter 20 to inhibit fuel gelling. When the temperature of tank fuel received by tank fuel port 120 is above the predetermined value, valve 128 moves back to a fully closed position to inhibit mixing of drain fuel from second passage 126 with supply fuel in first passage 124. When the temperature of tank fuel received by tank fuel port 120 falls farther below the predetermined value, valve 128 opens to a greater extent that when the tank fuel is just below the predetermined value. In this manner, the farther the tank fuel temperature is below the predetermined value, the more valve 128 opens to provide greater amounts of higher temperature drain fuel for mixing with the lower temperature tank fuel. Valve 128 becomes increasingly opened for a range of temperatures below the predetermined value, and when the tank fuel temperature is below the range, valve 128 moves to a fully opened position to provide a maximum amount of higher temperature drain fuel for mixing with the lower temperature tank fuel.

Referring back to FIG. 11, bracket 104 includes a body 132 having a plurality of openings (not shown) that align with openings 112 of mounting bosses 110 to receive fasteners 114 for attaching manifold 100 to bracket 104. Bracket also includes a plurality of legs 136, 138, 140 (three shown) configured to attach bracket 104 to engine 12 or a vehicle chassis. Each leg 136, 138, 140 includes an opening (not shown) that receives a fastener 142 that is also received by a corresponding opening (not shown) on engine 12 or the vehicle chassis.

Conduit 106 includes a first end 144 having a fitting configured to couple to a conventional drain port such as port 27 of manifold 22 (FIG. 4), a second end 146 having a fitting configured to couple to drain input port 116 of manifold 100, and a body 148 extending between ends 144, 146 to transport fuel from the drain port on the engine to drain input port 116.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.”

Systems, methods and apparatus are provided herein. In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic with the benefit of this disclosure in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. An engine mounted fuel manifold configured to inhibit gelling of fuel provided to a filter by mixing low temperature fuel from a fuel tank with higher temperature drain fuel from the engine, the manifold comprising:
a housing comprising an internal chamber configured to receive drain fuel from a fuel pump, a fuel accumulator and at least one fuel injector, and a recirculation passage in fluid communication with the internal chamber to receive the drain fuel;
a tank fuel port configured to receive fuel from the fuel tank;
an output port configured to output fuel to the filter;
a fuel supply passage in communication with the tank fuel port and the output port; and
a thermal recirculation valve in fluid communication with the recirculation passage and the fuel supply passage, the valve being configured to respond to temperatures of fuel received by the tank fuel port being below a predetermined value by mixing drain fuel from the recirculation passage with fuel in the fuel supply passage, thereby causing mixed fuel to be supplied from the output port to the filter.

2. The manifold of claim 1, wherein the housing comprises a drain fuel housing and a thermal recirculation valve housing extending from the drain fuel housing, the internal chamber being disposed in the drain fuel housing, the fuel supply passage being disposed in the thermal recirculation valve housing and the recirculation passage extending between the drain fuel housing and the thermal recirculation valve housing.

3. The manifold of claim 1, further comprising a mounting flange extending from the housing and configured to receive at least one fastener to attach the housing to the engine.

4. The manifold of claim 1, wherein the housing comprises a high pressure pump (“HPP”) port configured to receive drain fuel from a HPP, a rail port configured to receive drain fuel from a fuel accumulator, an injector port configured to receive drain fuel from at least one fuel injector, and a drain port configured to provide drain fuel to the fuel tank, the HPP port, the rail port, the injector port and the drain port being in fluid communication with the internal chamber.

5. The manifold of claim 1, wherein the thermal recirculation valve responds to temperatures of fuel received by the tank fuel port being above the predetermined value by moving to a fully closed position and responds to temperatures of fuel received by the tank fuel port being in a temperature range below the predetermined value by moving to a partially opened position.

6. The manifold of claim 5, wherein the thermal recirculation valve responds to temperatures of fuel received by the tank fuel port being below the temperature range by moving to a fully opened position.

7. The manifold of claim 6, wherein the thermal recirculation valve is movable between a plurality of partially opened positions in response to a corresponding plurality of temperatures of fuel received by the fuel tank port within the temperature range.

8. A fuel manifold, comprising:
a mounting flange configured to mount the manifold to an engine;
a drain fuel housing extending from the mounting flange; and
a thermal recirculation valve (“TRV”) housing extending from the drain fuel housing;
the drain fuel housing comprising a high pressure pump (“HPP”) port configured to receive drain fuel from an HPP, a rail port configured to receive drain fuel from a fuel accumulator, an injector port configured to receive drain fuel from at least one fuel injector, a drain port configured to output drain fuel to a fuel tank, an internal chamber in fluid communication with the HPP port, the rail port, the injector port and the drain port, and a recirculation passage in fluid communication with the internal chamber;
the TRV housing comprising a tank fuel port configured to receive fuel from the fuel tank, an output port configured to output fuel to a filter that supplies fuel to the engine, and a valve in fluid communication with the recirculation passage, the tank fuel port and the output port;
wherein the valve is configured to permit fuel flow from the recirculation passage to the output port in response to a temperature of fuel received by the tank fuel port being below a predetermined value, thereby increasing a temperature of fuel output by the output port to the filter and inhibiting fuel gelling.

9. The manifold of claim 8, wherein the valve responds to temperatures of fuel received by the tank fuel port being above the predetermined value by moving to a fully closed position and responds to temperatures of fuel received by the tank fuel port being in a temperature range below the predetermined value by moving to a partially opened position.

10. The manifold of claim 9, wherein the valve responds to temperatures of fuel received by the tank fuel port being below the temperature range by moving to a fully opened position.

11. The manifold of claim 10, wherein the valve is movable between a plurality of partially opened positions in response to a corresponding plurality of temperatures of fuel received by the fuel tank port within the temperature range.

12. A method of inhibiting gelling in an engine fuel supply path under low temperature operating conditions, comprising:
routing drain fuel from a fuel pump, a fuel accumulator and at least one fuel injector to an internal chamber of a fuel manifold;
routing tank fuel from a fuel tank through a fuel supply passage in the fuel manifold to a filter in the fuel supply path;
mixing drain fuel from the internal chamber with tank fuel in the fuel supply passage in response to the tank fuel being below a predetermined temperature; and
providing the mixed fuel to the filter.

13. The method of claim 12, wherein mixing comprises providing a thermal recirculation valve between the internal chamber and the fuel supply passage, the thermal recirculation valve responding to the tank fuel being below the predetermined temperature by moving to an opened position, thereby routing drain fuel from the internal chamber to the fuel supply passage.

14. The method of claim 13, further comprising routing drain fuel from the internal chamber through a recirculation passage in communication with the internal chamber and the thermal recirculation valve.

15. The method of claim 13, further comprising mounting the fuel manifold to an engine.

16. A vehicle mounted fuel manifold assembly for inhibiting gelling of fuel provided to a filter in low temperature conditions by mixing low temperature fuel from a fuel tank with higher temperature drain fuel from an engine, the assembly comprising:
a manifold housing comprising a drain input port, a drain output port, a tank fuel port, an output port, a first passage in flow communication with the drain input port and the drain output port, a second passage in flow communication with the tank fuel port and the output port, and a thermal recirculation valve in flow communication with the first passage and the second passage;
a bracket configured to mount to the vehicle;
at least one fastener for mounting the manifold housing to the bracket; and
a conduit comprising a first end configured to couple to a drain port on the engine, a second end configured to couple to the drain input port of the manifold housing and a body configured to transport fuel from the drain port on the engine to the drain input port of the manifold housing;
wherein the thermal recirculation valve is configured to respond to a temperature of fuel received from the fuel tank by the tank fuel port being below a predetermined value by routing higher temperature drain fuel from the first passage to the second passage to increase the temperature of fuel provided from the output port to the filter to inhibit gelling.

17. The manifold assembly of claim 16, wherein the thermal recirculation valve responds to temperatures of fuel received by the tank fuel port being above the predetermined value by moving to a fully closed position and responds to temperatures of fuel received by the tank fuel port being in a temperature range below the predetermined value by moving to a partially opened position.

18. The manifold assembly of claim 17, wherein the thermal recirculation valve responds to temperatures of fuel received by the tank fuel port being below the temperature range by moving to a fully opened position.

19. The manifold assembly of claim 18, wherein the thermal recirculation valve is movable between a plurality of partially opened positions in response to a corresponding plurality of temperatures of fuel received by the fuel tank port within the temperature range.

20. The manifold assembly of claim 19, wherein the manifold housing further comprises a recirculation passage in communication with the first passage and the thermal recirculation valve.
